(19) United States
(12) Patent Application Publication
(10) Pub. No.: US 2005/0257095 A1
(43) Pub. Date: Nov. 17, 2005

(54) Apparatus and method for detecting and indicating faults on a motherboard

(75) Inventor: Mark Rapaich, Westfield, IA (US)

Correspondence Address: SUITER- WEST-SWANTZ PC LLC, 14301 FNB PARKWAY SUITE 220, OMAHA, NE, 68154-5299, US

(73) Assignee: Gateway, Inc.

(21) Appl. No.: 10/828,983

(22) Filed: Apr. 21, 2004

(51) Int. Cl. G06F 11/00

(52) U.S. Cl. 714/42

(57) ABSTRACT

An apparatus and a method of the present invention provide diagnostics to defect faults on the motherboard of a computer system and to indicate the faults without having operating system fully functioning. When power is applied to the motherboard, a visual indicator may be turned on. After diagnostics performs a successful initialization of the motherboard and onboard integrated circuits, the visual indicator may be turned off. The faults on the mother board may be isolated from faults of other components in the computer system so that the user can detect the motherboard problem easily. Further, the visual indicator may flash if the diagnostics detect problems in the memory subsystem. The apparatus and the method of the present invention may require few modifications to the computer system thus incurring very small cost.

### FIELD OF THE INVENTION

The present invention relates generally to diagnostics for a computer and specifically to an apparatus and method for detecting and indicating faults of a motherboard at initialization phase of the motherboard.

### BACKGROUND OF THE INVENTION

As computer systems are being used in an increasing number of applications, their internal complexity is also increased greatly so that most users are unfamiliar with the internal design and configuration of the computers used today. Consequently, when a computer fails to operate due to failures of the components in the computer, the user is often unable to determine the source of the problem or how to resolve the problem.

Various means are provided to enable the user to try to resolve the computer failure problems. Current personal computers are typically equipped with some form of internal diagnostics, the purpose of which is to detect and isolate component faults within the personal computer architecture. For instance, diagnostics may consist of a series of instructions executed by the CPU within the computer system to allow self-diagnosis. Such diagnostics may test and report on the operational status or functionality of components within the computer, allowing a user to repair or replace components that are not functioning.

Diagnostics may be embedded in a nonvolatile memory. The embedded diagnostics have been widely employed in personal computers including a Read Only Memory (ROM) to store diagnostics routines as firmware. One type of embedded diagnostics is power-on self-test (POST) diagnostics, generally stored in basic input-output system (BIOS) ROM in personal computers. The POST is a series of tests that the computer performs on its components each time the computer is turned on. The POST begins by reading system configuration information that has either been hard-wired or stored in nonvolatile memory. It then checks random access memory (RAM) by writing to and reading from the RAM to ensure proper operation. The POST next examines external disk drives to confirm that they match the system configuration information. Lastly, the POST initiates boot sequences to load the operating system.

Conventionally, failure during execution of the POST has been used to isolate a fault area for proper diagnosis. Each phase of the POST routine involves a check of major components such as memories, hard disk drives, diskette drives and operating system. However, in order for the user to utilize diagnostic information from execution of the POST, certain components of a computer such as a CPU, address and data buses, bus controller and the like are required to function. Some failures may occur before those components fully function and the BIOS ROM may not be available to provide the POST routines to CPU. As a result, the POST may not be executable any more to diagnose failures. For example, in the event of a blank screen of a computer, the user may suspect a failure on the motherboard. However, the user may not be sure of the failure on the motherboard since the event occurs before the POST diagnostics are available. The user may have to assume that it could be a failure of the motherboard, a failure of any one of the devices on a peripheral card, a fault occurring in any one of the slots or the like, which may also render the CPU unable to retrieve further instruction of the POST. Therefore, the embedded diagnostics may not be useful to isolate the motherboard failure from other failures occurred during pre-booting phase.

Consequently, it would be advantageous if simple diagnostics can detect a failure of the motherboard during pre-booting time even if the CPU is unable to retrieve diagnostics from the ROM. It would also be advantageous, if such diagnostics require minimal cost and parts to detect and indicate the failure of the motherboard with very few modifications to the computers.

### SUMMARY OF THE INVENTION

Accordingly, the present invention is directed to an apparatus and a method that provides diagnostics to defect faults on the motherboard of a computer system and to indicate the faults without having operating system fully functioning. An apparatus and a method for detecting and indicating faults on the motherboard may comprise a visual indicator coupled to a CPU via an I/O port. When power is applied to the motherboard, the visual indicator may be turned on. After diagnostics performs a successful initialization of the motherboard and the integrated circuits, the visual indicator may be turned off. In an advantageous aspect of the present invention, the user may be informed of the faults on the motherboard by looking at the visual indicator. When there is no sign of faults on the motherboard, then the user may check other components of the computer for the problem. Alternatively, the visual indicator may flash if the diagnostics detect problems on other components of the computer such as a memory subsystem. In another advantageous aspect of the present invention, the method and the apparatus of the present invention may require minimal cost and parts to detect and indicate the failure of the motherboard with very few modifications to the computers.

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a schematic block diagram illustrating an exemplary computer system in accordance with the present invention;

FIG. 2 is a flowchart describing the method for providing fault indicator of the initialization of the motherboard of an embodiment in accordance with the present invention; and

FIG. 3 is a flow chart describing the method for providing fault indicator of the initialization of the memory subsystem of an alternative embodiment in accordance with the present invention.

### DETAILED DESCRIPTION OF THE INVENTION

Reference will now be made in detail to the presently preferred embodiments of the invention, examples of which are illustrated in the accompanying drawings.

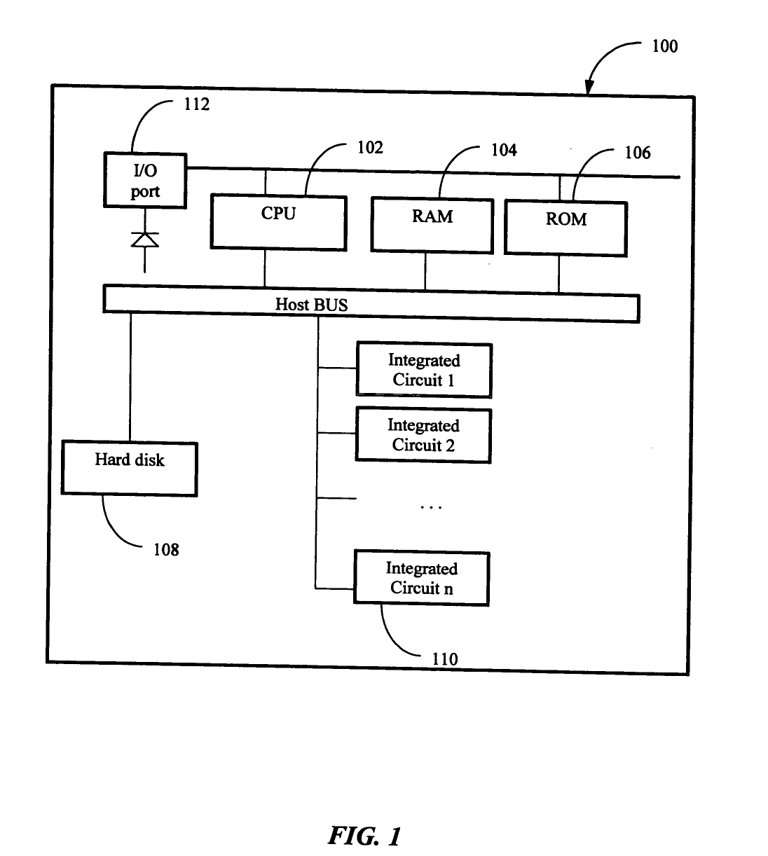

Referring to FIG. 1, a schematic block diagram illustrating an exemplary computer system 100 in accordance with the present invention is shown. A computer system 100 may comprise a control processing unit (CPU) 102, a Random Access Memory (RAM) 104, a Read Only Memory (ROM) 106. An example of a ROM may be a Flash memory or an electrically erasable programmable ROM (EEPROM). The ROM 106 may be responsible for storing diagnostic instructions as well as bus management instructions, bootstrap initialization instructions and the like. One of the examples of diagnostics stored in the ROM 106 may be the basic input/output system (BIOS) routines that make sure all other integration circuits 110, hard disk 108 and CPU 102 are functioning properly.

Several integrated circuits 110 may be mounted on a motherboard. Further, the computer system 100 may also include a visual indicator such as light emitting diode (LED) 114 hardwired to the motherboard. For example, a red light emitting diode (LED) may be used as visual indicator for motherboard failure in order to be different from a green color visual indicator for the status of power. The visual indicator may be coupled to the CPU via a general I/O port 112 and the host bus, allowing the CPU 102 to provide signals to the visual indicator via the general I/O port 112. The visual indicator may be internally readable. The visual indicator may be readable only if the access cover to the chassis is removed. Alternatively, the visual indicator may be positioned to be externally readable. For example, the visual indicator may be positioned on the front panel of the computer. Furthermore, in an alternative embodiment, a flash circuit may be included to provide flashing visual indication when there is a problem on other components of the computer such as a memory subsystem or the like.

A conventional computer system may comprise a CPU capable of requesting and retrieving instructions from the BIOS ROM when the computer system is booted. Generally, the BIOS is software instructions fetched by CPU to start the operating system. The BIOS may also provide power-on self-test (POST) diagnostics for the components in the computer system. The POST is a series of tests that the computer performs on its components each time the computer is turned on. The POST begins by reading system configuration information that has either been hardwired or stored in a nonvolatile memory. It then checks the RAM by writing to and reading from the RAM to ensure proper operation. BIOS and POST instructions are well known to those skilled in the art. In an embodiment of the present invention, the BIOS may further contain instructions for CPU to turn off the visual indicator in case of a successful initialization of the motherboard and to activate a flash visual indicator in case of an unsuccessful initialization of other components of the computer (such as a memory subsystem). The POST next examines external disk drives to confirm that they match the system configuration information. Additionally, the BIOS may provide instructions to activate other BIOS ROMs on add-on cards installed in the computer. A small computer system interface (SCSI), graphic cards or the like may include their own BIOS ROMs. The BIOS may provide a set of low-level routines that manage keyboard, screen, serial and parallel ports and the like when the computer is booting.

A motherboard (a multi-layered printed circuit board) may be an integral part of most personal computers. The multi-layered fabrication technique are used so that some layers of a board can carry data for the BIOS, processors and memory buses while other layers carry voltage and ground returns with the path short-circuiting at intersection. During pre-booting time (before operating system begins the booting process), the CPU may execute instructions provided from the BIOS ROM to initialize the motherboard, each configurable integrated circuit, memories, add-on cards, and the like. If the CPU can not complete initialization of the motherboard and integrated circuits mounted on the motherboard, this may indicate a problem on the motherboard.

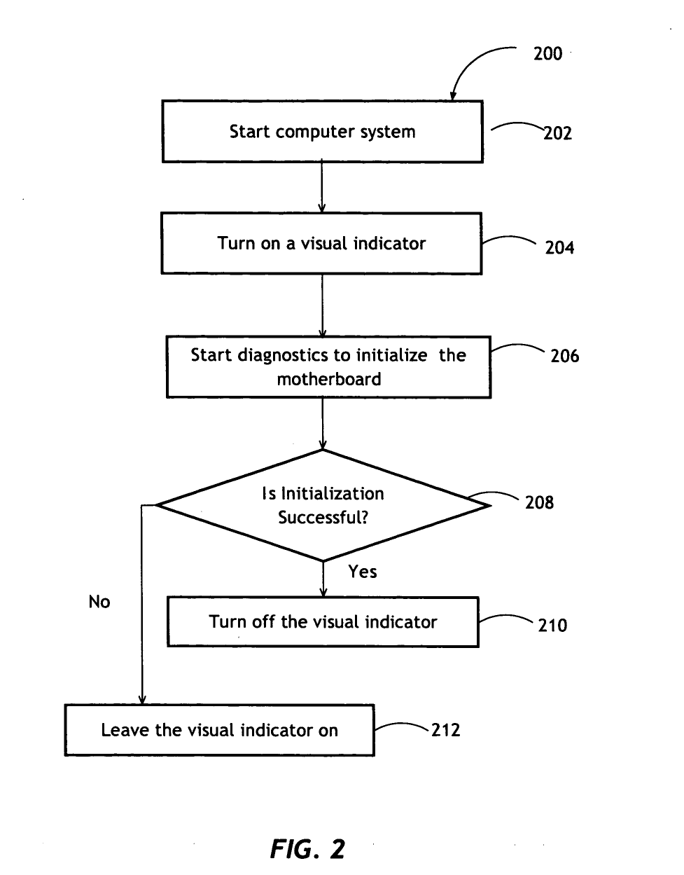

Referring now to FIG. 2, a flowchart describing the method for providing a fault indication of the initialization of the motherboard in accordance with the present invention is shown.

The process 200 may begin with the step in which the computer system starts upon reception of an initialization signal 202. The initialization signal may be generated when a user presses a power switch of the computer system. Additionally, a keyboard input (such as combination of CTRL-ALT-DEL keys), a power surge or interruption, operating system command for restart or the like may also generate the initialization signal so that the computer system starts (boot) or restart (reboot) its operating system. Upon reception of the initialization signal, the CPU which is capable of retrieving diagnostics from the ROM may send an initial request to retrieve diagnostics from the ROM. The visual indicator may be turned on when power is applied to the motherboard as a result of starting up the computer system 204. The CPU may execute the retrieved diagnostic instructions provided by the ROM to initialize the motherboard and integrated circuits mounted on the motherboard 206. The diagnostics may check whether it has initialized the motherboard and integrated circuits mounted on the motherboard (motherboard/integrated circuits) successfully 208 before the diagnostic proceeds with further initialization of add-on cards and external drives. When the diagnostics completes the initialization of motherboard/integrated circuits successfully, the diagnosis may instruct the CPU to turn off the visual indicator via the general purpose I/O port 210.

When the diagnostics are unable to initialize the motherboard/integrated circuits successfully, the visual indicator may be not turned off indicating a defective motherboard and integrated circuits mounted on the motherboard 212. For example, the diagnostics may employ a plurality of flags (a motherboard flag, a memory subsystem flag and the like) stored in the ROM. The flags may be turn on (e.g. having “1” value) at the starting up time. After successful initialization, the motherboard flag may be turned off (e.g. having “0” value). Otherwise, the motherboard flag remains to be turned on. The BIOS may instruct the CPU to check the value of the motherboard flag and turn off the visual indicator if the CPU finds the motherboard flag turned off. In an embodiment of the present invention, the diagnostics may allow the CPU to continue its initialization on other components after successful initialization of the motherboard. Thus, user may also utilize other diagnostic information that may be conventionally available for the computer system. For instance, the conventional BIOS for the personal computer system may not be interrupted if the motherboard/integrated circuits are successfully initialized. After the CPU may turn off the visual indicator, the BIOS may still find errors during the POST. In such case, the user may be notified by a series of beeps or a text message displayed on the screen together with the visual indicator. Lastly, the diagnostics may initiate the loading of the operating system and booting the computer system.

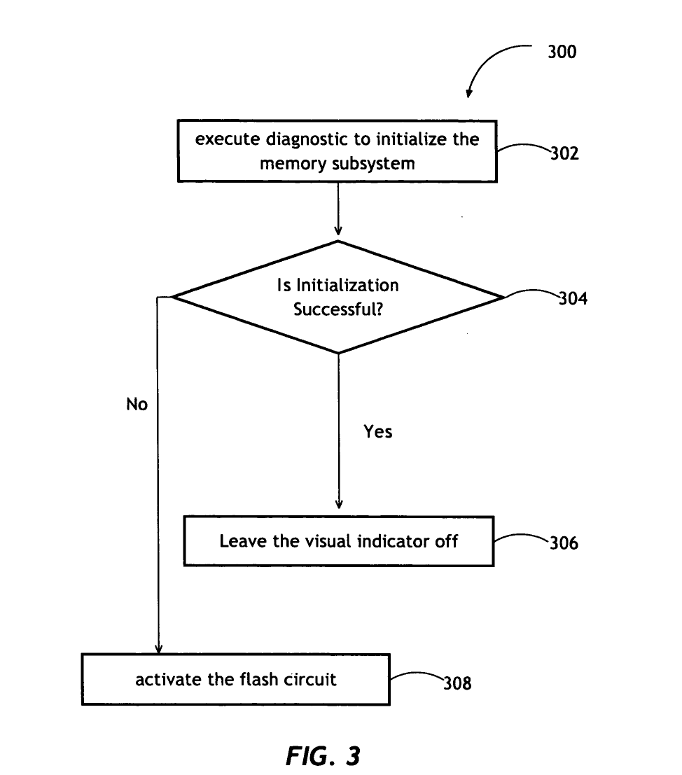

Now referring to FIG. 3, a flowchart describing the process 300 for providing a fault indication of the memory subsystem in an alternative embodiment of present invention. The process 300 may begin with the step in which the CPU executes diagnostics to initialize a memory subsystem 302. The memory subsystem may include a RAM, a DRAM, or the like. One of the examples of the initialization of the memory subsystem may be a verification of a RAM by performing a read/write test of each memory address. The CPU may check whether the diagnostics complete successful initialization of the memory subsystem 304. When there is a problem to initialize the memory subsystem, the CPU may signal the flash circuit via the general I/O port to activate a flashing visual indicator 306. When the diagnostics are able to initialize the memory subsystem successfully, the visual indicator may remain to be turned off 308. For example, the diagnostics may employ a plurality of flags (a motherboard flag, a memory subsystem flag and the like) stored in the ROM. The flags may be turn on (e.g. having “1” value) at the starting up time. After successful initialization, the memory subsystem flag may be turned off (e.g. having “0” value). Otherwise, the memory subsystem flag remains to be turned on. The BIOS may instruct the CPU to check the value of the memory flag and activate the flashing visual indicator if the CPU finds the memory subsystem flag turned on. As discussed above, when the memory subsystem is successfully initialized, the CPU may proceed with further execution of the diagnostics and initialize the boot sequence to load the operating system.

Although the invention has been described with a certain degree of particularity, it should be recognized that elements thereof may be altered by persons skilled in the art without departing from the spirit and scope of the invention. It is believed that the method for the present invention and many of its attendant advantages will be understood by the foregoing description, and it will be apparent that various changes may be made in the form, construction, and arrangement of the components thereof without departing from the scope and spirit of the invention or without sacrificing all of its material advantages, the form herein before described being merely an explanatory embodiment thereof. It is the intention of the following claims to encompass and include such changes.

1. An apparatus for detecting and indicating faults on a computer motherboard comprising:
a microprocessor capable of requesting and retrieving a plurality of diagnostic instructions, said microprocessor executing said retrieved plurality of diagnostic instructions when said microprocessor receives an initialization signal;
a nonvolatile memory device having said plurality of diagnostic instructions stored, said plurality diagnostic instructions initializing said computer motherboard; and
a visual indicator coupled to said microprocessor indicating a fault on said computer motherboard if said computer motherboard is not successfully initialized.

2. The apparatus for detecting and indicating faults on a computer motherboard as in claim 1, wherein said visual indicator is turned on when power is applied to said computer motherboard.

3. The apparatus for detecting and indicating faults on a computer motherboard as in claim 1, wherein said visual indicator is turned off upon detection of a fault on said computer motherboard.

4. The apparatus for detecting and indicating faults on a computer motherboard as in claim 1, further comprising a flash circuit activating a flash visual indicator upon detection of a fault on a memory subsystem.

5. The apparatus for detecting and indicating faults on a computer motherboard as in claim 1, wherein said nonvolatile memory device stores power-on self-test diagnostic instructions and basic input and output system instructions.

6. The apparatus for detecting and indicating faults on a computer motherboard as in claim 1 wherein said visual indicator is a light emitting diode.

7. The apparatus for detecting and indicating faults on a computer motherboard as in claim 1 wherein said visual indicator is an external visual indicator.

8. The apparatus for detecting and indicating faults on a computer motherboard as in claim 1 wherein said visual indicator is an internal visual indicator.

9. The apparatus for detecting and indicating faults on a computer motherboard as in claim 7, further comprising an I/O port coupled to said microprocessor, said microprocessor providing signals to said external visual indicator via said I/O port.

10. The apparatus for detecting and indicating faults on a computer motherboard as in claim 1, wherein said computer motherboard includes integrated circuits mounted on said computer motherboard.

11. A method for detecting and indicating faults on a computer motherboard comprising the steps of:
receiving an initialization signal to start a computer system;
turning on a visual indicator when power is applied to said computer motherboard;
requesting a plurality of diagnostic instructions stored a nonvolatile memory device upon reception of an initialization signal;
retrieving said plurality of diagnostic instructions;
initializing said computer motherboard by executing said retrieved plurality of diagnostic instructions; and
turning off said visual indicator when said computer motherboard is successfully initialized.

12. The method for detecting and indicating faults on a computer motherboard as in claim 11, further comprising the steps of:
initializing a memory subsystem; and
activating a flash visual indicator when a fault is found on said memory subsystem.

13. The method for detecting and indicating faults on a computer motherboard as in claim 11, wherein said nonvolatile memory device stores power-on self-test diagnostic instructions and basic input and output system instructions.

14. The method for detecting and indicating faults on a computer motherboard as in claim 11, wherein said visual indicator is a light emitting diode.

15. The method for detecting and indicating faults on a computer motherboard as in claim 11, wherein said visual indicator is an external visual indicator.

16. The method for detecting and indicating faults on a computer motherboard as in claim 11, wherein said visual indicator is an internal visual indicator.

17. The method for detecting and indicating faults on a computer motherboard as in claim 15, further comprising the step of initiating an I/O port coupled to said microprocessor, said microprocessor providing signals to said external visual indicator via said I/O port when said computer motherboard is not initialized successfully.

18. The method for detecting and indicating faults on a computer motherboard as in claim 11, wherein said computer motherboard includes integrated circuits mounted on said computer motherboard.

19. An apparatus for detecting and indicating faults in a computer motherboard comprising:
means for receiving an initialization signal to start a computer system;
means for turning on a visual indicator when power is applied to said computer motherboard;
means for storing a plurality of diagnostic instructions;
means for requesting and retrieving said plurality of diagnostic instructions upon reception of an initialization signal;
means for executing said retrieved plurality of diagnostic instructions to initialize said computer motherboard;
means for turning off said visual indicator when no fault is found on said computer motherboard.

20. The apparatus for detecting and indicating faults on a computer motherboard as in claim 19, further comprising:
means for initializing a memory subsystem; and
means for activating a flash indicator when a fault is found on memory subsystem.

21. The apparatus for detecting and indicating faults on a computer motherboard as in claim 19, wherein said visual indicator is an external visual indicator.

22. The apparatus for detecting and indicating faults on a computer motherboard as in claim 19, wherein said visual indicator is an internal visual indicator.

23. The apparatus for detecting and indicating faults on a computer motherboard as in claim 19, wherein said storing diagnostics means includes means for storing power-on self-test diagnostic instructions and basic input and output system instructions.

24. The apparatus for detecting and indicating faults on a computer motherboard as in claim 19, wherein said visual indicator is a light emitting diode.

25. The apparatus for detecting and indicating faults on a computer motherboard as in claim 21, further comprising means for providing a signal to said visual indicator via an I/O port.

26. An apparatus for detecting and indicating faults on a computer motherboard comprising:
a host bus for transmitting address and data signals;
a nonvolatile memory device couple to said host bus having a plurality of diagnostic instructions stored, said a plurality of diagnostic instructions including power-on self-test diagnostic instructions and basic input and output system instructions;
a microprocessor couple to said host bus, said microprocessor capable of request and retrieving said plurality of diagnostic instructions upon reception of an initialization signal to start a computer system and executing said retrieved plurality of diagnostic instructions;
a visual indicator coupled to said microprocessor being turned on when power is applied to said computer motherboard;
a general I/O port coupled to said microprocessor turning said visual indictor off when said computer mother board is not initialized successfully, said microprocessor initializing said computer motherboard by executing said a plurality of diagnostic instructions; and
a flash circuit coupled to said microprocessor flashing said visual indicator when a failure is found in a memory subsystem after said computer motherboard initialization.

27. The apparatus for detecting and indicating faults on a computer motherboard as in claim 26, wherein said external visual indicator is located on panel of said computer system.

28. The apparatus for detecting and indicating faults on a computer motherboard as in claim 26, wherein said computer motherboard comprises integrated circuit mounted on said computer motherboard.
